(19) United States
(12) Patent Application Publication
(10) Pub. No.: US 2024/0265318 A1
(43) Pub. Date: Aug. 8, 2024

(54) ADAPTIVE, PERSONALIZED MANAGEMENT SYSTEM FOR TRAINING COMPLIANCE

(71) Applicant: International Business Machines Corporation, Armonk, NY (US)

(72) Inventors: Rachel Ostrand, White Plains, NY (US); James Philip O'Connor, White Plains, NY (US)

(21) Appl. No.: 18/165,460

(22) Filed: Feb. 7, 2023

(51) Int. Cl. G06Q 10/0631; G06Q 10/1093

(52) U.S. Cl. CPC G06Q 10/063114; G06Q 10/1097

(57) ABSTRACT

Computer-implemented methods for an adaptive, personalized system for managing training compliance. Aspects include receiving behavior data associated with a user of a training compliance management system. Aspects further include updating a personalized predictive behavior model associated with the user using the behavior data. Aspects also include generating, using the personalized predictive behavior model, a training duration, a reminder type, and a reminder time for the user. Aspects include generating sub-units of a training unit that each have a completion time within a threshold of the training duration for the user. Aspects further include generating a reminder based on the reminder type comprising an uncompleted sub-unit of the sub-units of the training unit. Aspects include transmitting the reminder to the user at the reminder time.

### BACKGROUND

The present invention generally relates to training compliance, and more specifically, to computer systems, computer-implemented methods, and computer program products for adaptive personalized training compliance management.

Companies often require employees to complete training and employee education courses. Ensuring and enforcing compliance of the trainings is cumbersome and puts unnecessary strain on resources. For example, current systems email reminders to employees. If the emails are ignored and the trainings are not completed, higher-level managers need to take time to contact the employees to encourage compliance by a stated deadline and follow-up with the employees to ensure that the trainings have been completed. The time the managers dedicate to ensure compliance in trainings is often taken from other existing projects that require their time and attention.

### SUMMARY

Embodiments of the present invention are directed to a computer-implemented method for adaptive, personalized system for managing training compliance. According to an aspect, a computer-implemented method includes receiving behavior data associated with a user of a training compliance management system. The method also includes updating a personalized predictive behavior model associated with the user using the behavior data. The method further includes generating, using the personalized predictive behavior model, a training duration, a reminder type, and a reminder time for the user. The method includes generating sub-units of a training unit that each have a completion time within a threshold of the training duration for the user. The method further includes generating a reminder based on the reminder type comprising an uncompleted sub-unit of the sub-units of the training unit. The method also includes transmitting the reminder to the user at the reminder time.

In one embodiment of the present invention, the behavior data further comprises a time of day, a duration of a session, and a type of reminder associated with a previously completed training unit.

In one embodiment of the present invention, the method further includes identifying a set of users with a common characteristic and generating a semi-specialized predictive behavior model using personalized predictive behavior models corresponding to each user of the set of users. The method further includes receiving an indication of a new user associated with the common characteristic, generating a training reminder for the new user using the semi-specialized predictive behavior model, and transmitting the training reminder to the new user at a time determined using the semi-specialized predictive behavior model.

In one embodiment of the present invention, wherein the reminder type is a text message, a social media message, an email, or a phone call.

In one embodiment of the present invention, the method further includes, in response to identifying a different uncompleted sub-unit of the training unit associated with the user, generating a different reminder comprising the different uncompleted sub-unit of the training unit and transmitting the different reminder to the user at another time determined using the personalized predictive behavior model.

In one embodiment of the present invention, the method further includes, in response to determining that there are no uncompleted sub-units associated with the training unit, generating a notification indicating completion of the training unit and transmitting the notification to the user.

According to another non-limiting embodiment of the invention, a system having a memory having computer readable instructions and one or more processors for executing the computer readable instructions, the computer readable instructions controlling the one or more processors to perform operations. The operations include receiving behavior data associated with a user of a training compliance management system. The operations further include updating a personalized predictive behavior model associated with the user using the behavior data. The operations also include generating, using the personalized predictive behavior model, a training duration, a reminder type, and a reminder time for the user. The operations include generating sub-units of a training unit that each have a completion time within a threshold of the training duration for the user. The operations also include generating a reminder based on the reminder type comprising an uncompleted sub-unit of the sub-units of the training unit. The operations further include transmitting the reminder to the user at the reminder time.

According to another non-limiting embodiment of the invention, a computer program product for adaptive, personalized system for managing training compliance is provided. The computer program product includes a computer-readable storage medium having program instructions embodied therewith, the program instructions executable by a processor to cause the processor to perform operations. The operations include receiving behavior data associated with a user of a training compliance management system. The operations further include updating an adaptive personalized training compliance management predictive behavior model associated with the user using the behavior data. The operations also include generating, using the personalized predictive behavior model, a training duration, a reminder type, and a reminder time for the user. The operations include generating sub-units of a training unit that each have a completion time within a threshold of the training duration for the user. The operations also include generating a reminder based on the reminder type comprising an uncompleted sub-unit of the sub-units of the training unit. The operations further include transmitting the reminder to the user at the reminder time.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 is a block diagram of a system for an adaptive, personalized system for managing training compliance in accordance with one or more embodiments of the present invention;

FIG. 3 is a diagram of how different types of predictive behavior models are generated for the adaptive, personalized system for managing training compliance in accordance with one or more embodiments of the present invention;

FIG. 4 is a flowchart of a method for an adaptive, personalized system for managing training compliance to build a personalized predictive behavior model based on the prior behavior of the user with the system in accordance with one or more embodiments of the present invention; and

FIG. 5 is a flowchart of a method for generating a semi-specialized predictive behavior model for the adaptive, personalized system for managing training compliance in accordance with one or more embodiments of the present invention.

### DETAILED DESCRIPTION

As discussed above, companies often require their employees to complete training and employee education courses. Ensuring compliance of the completion of such courses can be challenging for large organizations where users can ignore reminders and leave trainings incomplete. Current systems include the use of email reminders and escalation of incomplete trainings to managers to intervene and encourage completion of the trainings. The managers may need to redirect their time and attention from projects to enforce compliance of such trainings, which may negatively impact those projects and the performance of the managers.

Disclosed herein are methods, systems, and computer program products for an adaptive, personalized system for managing training compliance which generate personalized predictive behavior models for users based on their past behavior and interactions with the system. The personalized predictive behavior models can be used to generate reminders at a time a user is most likely to complete a training based on their past behavior. The system utilizes a variable length of time to complete a training unit or a sub-unit of the training unit as a key adjustable parameter and pairs it with the availability of the user. The system generates reminders and transmits sub-units of the training unit to maximize the likelihood of completion by the user by sending reminders at an ideal time for the user based on their past behavior and current availability, using a mode of communication that has triggered a responsiveness from the user, and providing sub-units (e.g., segmented or divided units of the training unit) that can be completed in a single session for the user.

The systems and methods described herein analyze the time of day that users across the company work on trainings, duration of work sessions for completing the trainings, and methods of notifications used by the users to launch trainings to create a generalized, adaptive predictive behavior model of the most effective times, methods of informing, reminding users of a training for them to complete, and then delivers a correctly-sized chunk of training that users can complete during the predicted available time in a single sitting.

In addition, the system can generate semi-specialized predictive behavior models by extrapolating data from identified users that share similarities based on behavioral or demographic characteristics. The semi-specialized predictive behavior model can be used as a starting point or template for new users that also share the similarities of the identified users.

As the tenure of the user increases and more behavior data is collected on their personal habits, then the predictive behavior model associated with the user can be more personalized to better predict their future behaviors in conjunction with completing their assigned trainings.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

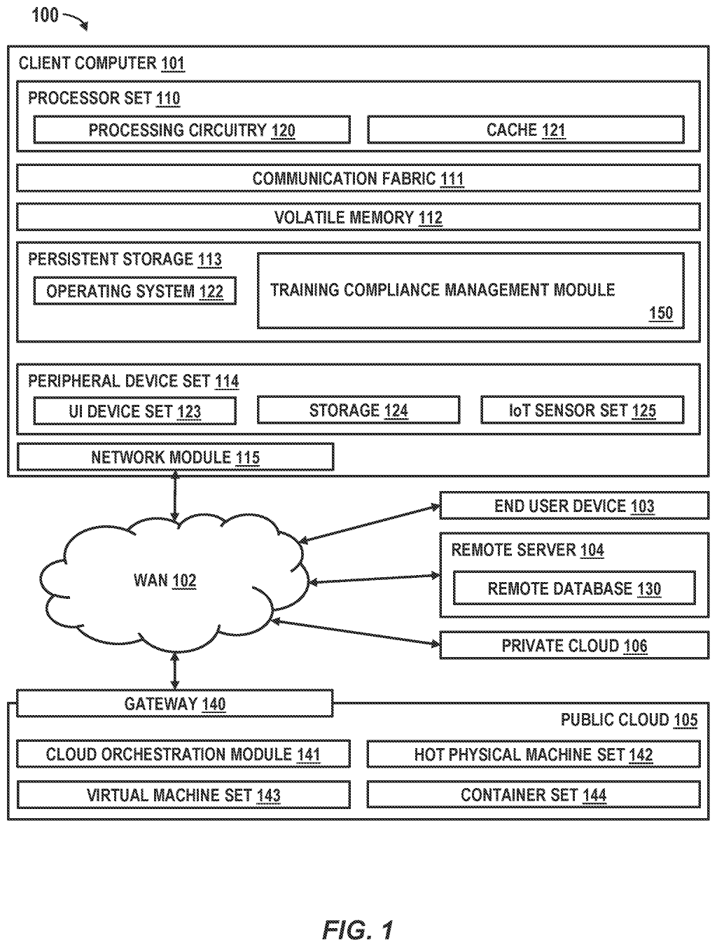

Referring now to FIG. 1, computing environment 100 contains an example of an environment for the execution of at least some of the computer code involved in performing the inventive methods, such as generating personalized predictive behavior models for training compliance 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Client computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

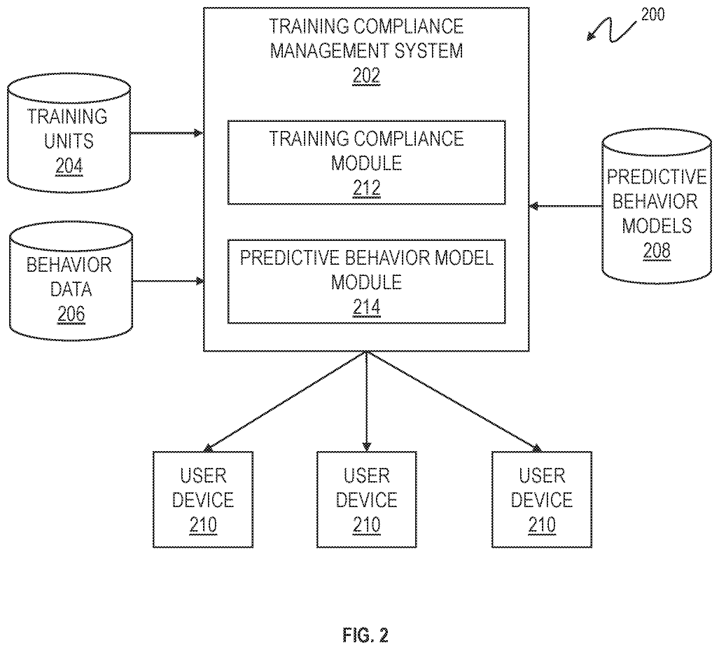

Referring now to FIG. 2, a system 200 for an adaptive, personalized system for managing training compliance in accordance with one or more embodiments of the present invention is shown. In exemplary embodiments, the system 200 includes a training compliance management system 202 that may be embodied in a computer 101, such as the one shown in FIG. 1. As illustrated, the system 200 includes a training compliance management system 202 that is configured to generate, update and/or modify personalized predictive behavior models associated with users to generate and transmit reminders and training sub-units of a training unit based on behavioral data associated with the user.

In exemplary embodiments, the training compliance module 212 assigns training units 204 to users and tracks their respective completion of the training units 204. The training compliance module 212 assigns a training unit 204 to either all of the users in an organization or business or a sub-set of users of the organization or business and assigns a due date by which the training unit 204 needs to be completed. The training compliance module 212 tracks the progress of each user assigned the training unit 204.

The training compliance module 212 manages the compliance of users to complete training units 204 by specified due dates by generating reminders that include sub-units of the training units 204 that are associated with users and collecting behavior data 206 from the completion of training units 204. Examples of behavior data include but are not limited to, the time (e.g., day of week, time of day, etc.) a user worked on a previous training unit, a method of notification to which the user responded to launch the training unit, how long the user spent working on the previous training unit in one session. The training compliance module 212 uses information generated by the predictive behavior model (PBM) module 214 to generate the reminders to the users, such as the type of reminder to generate, a time of day when the reminder is to be transmitted, a training duration associated with the user, and the like. A training duration is an estimated length of time a user is likely to spend on a sub-unit of the training unit based on his previous behavior (e.g., previous durations of sessions to complete training units by a user).

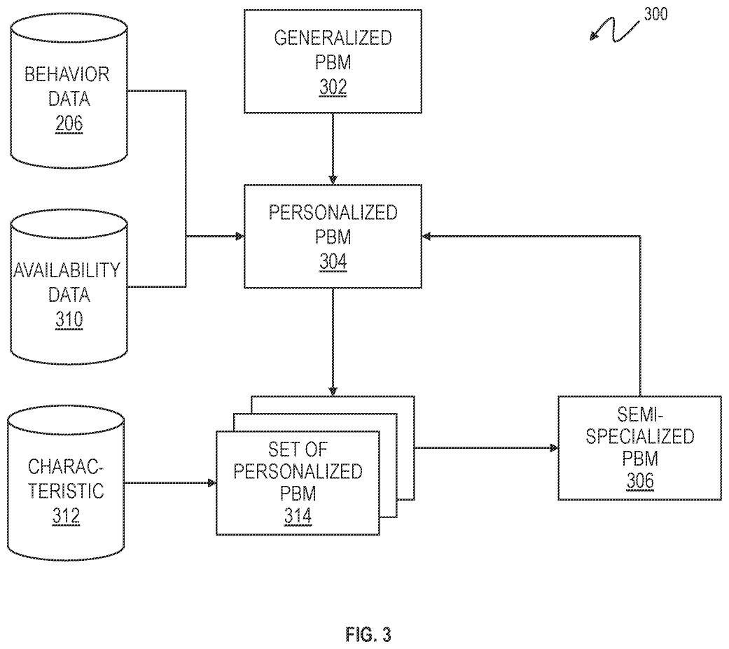

In exemplary embodiments, the PBM module 214 of the training compliance management system 202 is configured to generate, update, and/or modify predictive behavior models 208 of the training compliance management system 202 based on behavior data 206 obtained from users of the system 200. The different types of predictive behavior models 208 are discussed in relation to FIG. 3. The PBM module 214 utilizes one or more machine learning algorithms to generate, update, and/or modify personalized predictive behavior models 208 corresponding to each user of the training compliance management system 202. The PBM module 214 uses the predictive behavior models 208 corresponding to users to identify information based on their behavior data 206 and their availability (e.g., from their calendar) to generate personalized reminders and sub-units of the training units 204 to encourage users to complete training units 204. Behavior data 206 includes data from the completion of past training units, such as a time of day that the training unit 204 was completed, the duration of a session of a user while they completed the training unit 204, and the type of reminder that user responded to during the completion of the training unit 204, such as an email message, a social media message, a phone call, a text message, or the like. Behavior data 206 is generated on user devices 210 during a session where the user is completing a portion of the training unit 204.

In exemplary embodiments, the training compliance module 212 uses the data generated by the PBM module 214 using a predictive behavior model 208 corresponding to the user to generate a reminder for a user containing a sub-unit (or a link to the sub-unit) of the training unit 204. The sub-unit has a completion time within a threshold of the training duration generated by the PBM module 214 and associated with the user. The training compliance module 212 transmits the reminder at a time determined by the PBM module 214 for the user. The time the reminder is transmitted is also based on the availability of the user (e.g., based on their calendar availability). The training compliance module 212 tracks users progress of completing the training unit 204 and continues to generate and transmit reminders and sub-units of the training unit 204 until the completion of the training unit 204. Upon completion of the training unit 204, the training compliance module 212 generates and transmits a notification of the completion of the training unit to the user device 210 associated with the user and updates a record tracking completion of the training unit 204 by users to reflect the completion of the training unit 204 by the user.

Referring now to FIG. 3, a diagram 300 of how different types of predictive behavior models are generated for the adaptive, personalized system for managing training compliance is shown.

The PBM module 214 initially uses a generalized predictive behavior model 302 for users that are new to the training compliance management system 202 and there is minimal behavior data 206 associated with the user. In some embodiments, the generalized predictive behavior model 302 is a starting template that contains a default time (e.g., day of week, time of day) that users work on training units 204, a default method of notification for reminders, and a default session duration indicating how long users work on the training unit 204 in a session. In some embodiments, the generalized behavior model is a template that is an aggregation of all users of the training compliance management system 202 in a company or business.

As the PBM module 214 collects behavior data 206 for each user over time, the PBM module 214 generates and maintains a personalized predictive behavior model 304 for each user. The PBM module 214 continually updates the personalized predictive behavior model 304 for each user as it continues to collect behavior data 206 for each user. The PBM module 214 can use availability data 310, such as data obtained from the calendar availability of the user, to further personalize the generation of data for the training compliance module 212 to use to generate reminders associated with the training unit 204 for the user.

In exemplary embodiments, the PBM module 214 generates a semi-specialized predictive behavior model 306. The PBM module 214 identifies a group or set of personalized predictive behavior models 314 of users that share a common characteristic 312 (e.g., job role, member of a department, a working group, or a team, office location, type of worker, accommodation, or the like). The PBM module 214 uses the personalized predictive behavior model corresponding to each user of the identified set of personalized predictive behavior models 314 to generate a semi-specialized predictive behavior model 306 associated with the characteristic 312 of the group of users. The PBM module 214 uses one or more machine-learning techniques to generate the semi-specialized predictive behavior model 306 from the set of personalized predictive behavior models 314. The semi-specialized predictive behavior model 306 is used to generate reminders for new users of the training compliance management system 202 that are identified to share the common characteristic 312 of the group of users in lieu of using the generalized predictive behavior model 302, and/or to further refine the behavior of the generalized predictive behavior model 302.

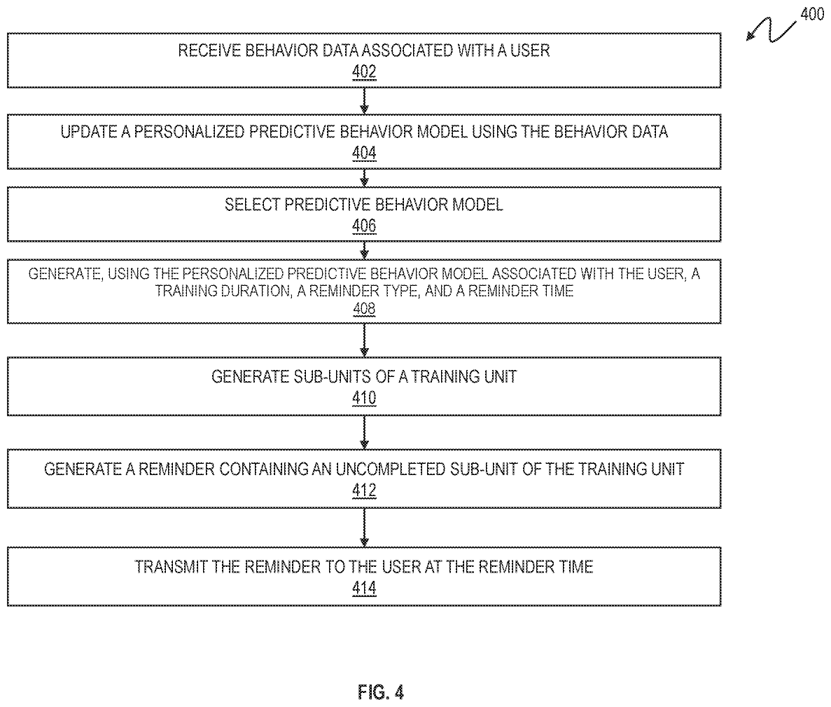

Referring now to FIG. 4, a flowchart of a method 400 for the adaptive, personalized system for managing training compliance in accordance with one or more embodiments of the present invention is shown. The method 400 begins at block 402 by receiving behavior data 206 associated with a user. The behavior data 206 is obtained from one or more user devices 210 associated with the user. The behavior data 206 includes metadata or historical data of the user collected on the user device in association with the completion of training unit 204 or previous interaction of the user with the system 200. The behavior data 206 includes data such as the time of day or week that the user worked on a previous training unit 204 and how long the user spent working on the training unit 204 in one session. The behavior data 206 further includes what method of notification the user responded to on the user device to launch or initiate the previous training unit 204, such as an email, a text message, social media message, phone call, or the like. For example, the user may consistently respond to text messages but ignore email messages to initiate a training unit 204.

The method 400 further includes updating or modifying a personalized predictive behavior model 304 using the behavior data 206 of the user, as shown in block 404. The PBM module 214 uses one or more machine learning algorithms to modify the personalized predictive behavior model 304 using the behavior data 206 of the user.

Next at block 406, the method includes selecting a predictive behavior model 208 to use for a user. If the PBM module 214 detects that the user is an existing user of the system, the PBM module 214 selects the existing personalized predictive behavior model 304 associated with the user. If a user is new to the system and is not associated with an existing personalized predictive behavior model 304, the PBM module 214 selects a generalized predictive behavior model 302 for the user and will personalize it using the behavior data 206 of the user collected by the system 200. If the PBM module 214 determines that the new user is associated with a characteristic 312 associated with a semi-specialized predictive behavior model 306, the PBM module 214 selects the semi-specialized predictive behavior model 306 for the new user and generates a personalized predictive behavior model 304 for the new user using the semi-specialized predictive behavior model 306 and the behavior data 206 associated with the user.

The method 400 further includes generating, using the personalized predictive behavior mode associated with the user, a training duration, a reminder type, and a reminder time, as depicted in block 408. The PBM module 214 generates a training duration which is indicative of an ideal duration of time associated with the user to complete a sub-unit of the training unit 204. The reminder type generated by the PBM module 214 is indicative of a method of notification that the user responded to in order to launch the previously completed training unit 204. The reminder time generated by the PBM module 214 is indicative of an ideal time (e.g., day of week, time of day) that is associated with the user to complete a sub-unit of the training unit 204.

Next, at block 410, the training compliance module 212 generates sub-units of the training unit 204 assigned to the user. The training compliance module 212 divides or segments the training unit 204 into sub-units that have completion times that are within a threshold of the training duration generated by the PBM module 214. The training compliance module 212 may take into consideration existing segments and required order of sequence of the training unit 204 when generating the sub-units.

For example, the training unit 204 may have a completion time that is about 2 hours (which indicates that it typically takes a user 2 hours to complete the training unit 204). The determined training duration generated by the PBM module 214 for the user may be 15 minutes, which indicates the user is likely to spend 15 minutes of time on the training during a single session of working on the training unit 204. The threshold may be a preset value, such as 5 minutes, indicating that sub-units of the training unit 204 can range from the training duration plus or minus the threshold (i.e., the sub-units can have a completion time ranging from 10 minutes to 20 minutes). The training compliance module 212 can divide or segment the training unit into 10 to 20 minutes segments based on the availability of the user (e.g., obtained from the calendar of the user). If the training unit 204 already has segments that are within that range, the sub-unit may use the existing segments. If the segments of the training unit are larger than the training duration (e.g., 30-minute segment) the training compliance module 212 can segment it into smaller segments that correspond to the training duration associated with the user. In some embodiments, the training compliance module 212 selects sub-units to deliver to the user based on their completion time. If training unit 204 requires a specific sequence of segments to be presented to the user, the training compliance module 212 will deliver the sub-units in accordance with that requirement.

At block 412, the training compliance module 212 generates a reminder that contains an uncompleted sub-unit of the training unit 204 or a link to the uncompleted sub-unit. The training compliance module 212 generates a reminder based on the reminder type associated with the user that was generated by the PBM module 214. The reminder includes information associated with the training unit (e.g., total completion time, due date of the training unit 204) and an uncompleted sub-unit or a link to the uncompleted sub-unit of the training unit 204.

At block 414, the training compliance module 212 transmits the reminder to the user at the reminder time associated with the user. The reminder time was generated by the PBM module 214 and is indicative of an ideal time of day or day of week for the user to complete the sub-unit based on their past behavior. The training compliance module 212 may also obtain user availability data 310, such as from a user calendar, to adjust the time the reminder is transmitted to ensure that the user receives the reminder during a period of time that they are free and able to complete the sub-unit of the training unit 204.

In some example embodiments, the training compliance module 212 receives data associated with sub-unit transmitted in the reminder. The data may be behavior data 206 associated with the user and the progress or completion of the sub-unit of the training unit 204. The behavior data 206 is updated to include the data received from the user device 210. The updated behavior data 206 may trigger the PBM module 214 to modify the personalized predictive behavior model 304 associated with the user using the new data. In some embodiments, the PBM module 214 updates the personalized predictive behavior model 304 at predetermined intervals (e.g., every week, every month, etc.). The training compliance module 212 tracks the progress of the user in completion of the sub-unit and may send an additional reminder at another time determined by the PBM module 214 to complete the incomplete sub-unit or may generate a new reminder with a different uncompleted sub-unit of the training unit 204. This process is iterated until there are no further incomplete sub-units of the training unit 204. The training compliance module 212 generates and transmits a notification to the user (e.g., to their associated user device 210) indicating that the training unit 204 is complete and updates its tracking of users and completion of the training unit 204 to reflect the same.

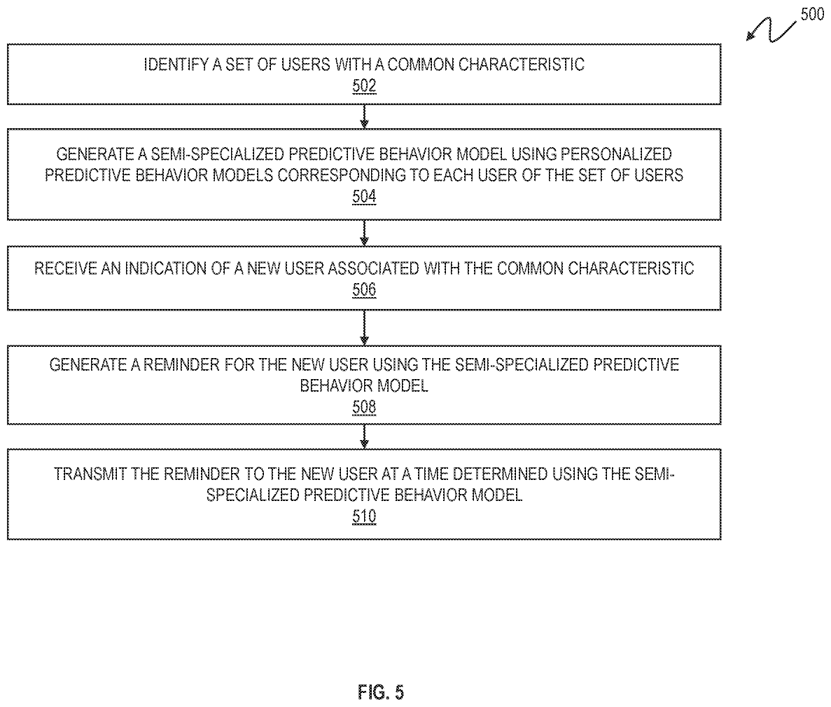

Referring now to FIG. 5, a flowchart of a method 500 for generating a semi-specialized predictive behavior model 306 for the adaptive, personalized system for managing training compliance in accordance with one or more embodiments of the present invention is shown. The method 500 begins at block 502 by identifying a set of users 314 with a common characteristic 312. The PBM module 214 receives an indication of a common characteristic 312, such as being a member of a department of an organization or business, a member of a working group, a member of a team, an office location of the user, the type of worker associated with a user (e.g., intern, full-time, part-time, administrative, etc.), or the like. The PBM module 214 identifies all, or a sub-set, of users associated with the common characteristic 312.

At block 504, a semi-specialized predictive behavior model 306 is generated using the set of personalized predictive behavior model 314 that are associated with the common character4istic 312. The PBM module 214 uses one or more machine learning techniques to generate the semi-specialized predictive behavior model 306 by extrapolating data from the set of personalized predictive behavior models 314 associated with the common characteristic 312. The semi-specialized predictive behavior model 306 can be stored and used as a template or starting point for any new users that share the same common characteristic 312.

At block 506, an indication of a new user associated with the common characteristic 312 is received. The training compliance module 212 receives the indication of the new user associated with the common characteristic 312. The training compliance module 212 identifies that semi-specialized predictive behavior model 306 associated with the common characteristic 312.

At block 508, a reminder for the new user is generated using the semi-specialized predictive behavior model 306. The PBM module 214 generates a training duration, a reminder type, and a reminder time for the new user using the methods described in connection with block 408 in FIG. 4. The training compliance module 212 further generates sub-units of a training unit 204 associated with the new user using the methods described in connection with block 410 of FIG. 4.

At block 510, the reminder is transmitted to the new user at a time determined using the semi-specialized predictive behavior model 306 associated with the new user. Similar to the methods described in block 408 of FIG. 4, the reminder time generated by the PBM module 214 is indicative of an ideal time of day or day of week for the new user to complete the sub-unit. As the training compliance management system 202 receives behavior data 206 associated with the new user, the PBM module 214 will generate and continue to adapt and modify the personalized predictive behavior model 304 for the new user to be used in conjunction with future training units.

In some embodiments, the training compliance management system 202 generates aggregate reports indicating the progress of users in completing the assigned training units 204. The reports may include data indicating when reminders were sent to users and their responsiveness to the reminders and progress in completion of the sub-units of the training units 204. Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving behavior data associated with a user of a training compliance management system;
updating a personalized predictive behavior model associated with the user using the behavior data;
generating, using the personalized predictive behavior model, a training duration, a reminder type, and a reminder time for the user;
generating sub-units of a training unit that each have a completion time within a threshold of the training duration for the user;
generating a reminder based on the reminder type comprising an uncompleted sub-unit of the sub-units of the training unit; and
transmitting the reminder to the user at the reminder time.

2. The computer-implemented method of claim 1, wherein the behavior data further comprises a time of day, a duration of a session, and a type of reminder associated with a previously completed training unit.

3. The computer-implemented method of claim 1, furthering comprising:
identifying a set of users with a common characteristic; and
generating a semi-specialized predictive behavior model using personalized predictive behavior models corresponding to each user of the set of users.

4. The computer-implemented method of claim 3, further comprising:
receiving an indication of a new user associated with the common characteristic;
generating a training reminder for the new user using the semi-specialized predictive behavior model; and
transmitting the training reminder to the new user at a time determined using the semi-specialized predictive behavior model.

5. The computer-implemented method of claim 1, wherein the reminder type is a text message, a social media message, an email, or a phone call.

6. The computer-implemented method of claim 1, further comprising:
in response to identifying a different uncompleted sub-unit of the training unit associated with the user, generating a different reminder comprising the different uncompleted sub-unit of the training unit; and
transmitting the different reminder to the user at another time determined using the personalized predictive behavior model.

7. The computer-implemented method of claim 1, further comprising:
in response to determining that there are no uncompleted sub-units associated with the training unit, generating a notification indicating completion of the training unit; and
transmitting the notification to the user.

8. A system comprising:
a memory having computer readable instructions; and
one or more processors for executing the computer readable instructions, the computer readable instructions controlling the one or more processors to perform operations comprising:
receiving behavior data associated with a user of a training compliance management system;
updating a personalized predictive behavior model associated with the user using the behavior data;
generating, using the personalized predictive behavior model, a training duration, a reminder type, and a reminder time for the user;
generating sub-units of a training unit that each have a completion time within a threshold of the training duration for the user;
generating a reminder based on the reminder type comprising an uncompleted sub-unit of the sub-units of the training unit; and
transmitting the reminder to the user at the reminder time.

9. The system of claim 8, wherein the behavior data further comprises a time of day, a duration of a session, and a type of reminder associated with a previously completed training unit.

10. The system of claim 8, wherein the operations further comprise:
identifying a set of users with a common characteristic; and
generating a semi-specialized predictive behavior model using personalized predictive behavior models corresponding to each user of the set of users.

11. The system of claim 10, wherein the operations further comprise:
receiving an indication of a new user associated with the common characteristic;
generating a training reminder for the new user using the semi-specialized predictive behavior model; and
transmitting the training reminder to the new user at a time determined using the semi-specialized predictive behavior model.

12. The system of claim 8, wherein the reminder type is a text message, a social media message, an email, or a phone call.

13. The system of claim 8, wherein the operations further comprise:
in response to identifying a different uncompleted sub-unit of the training unit associated with the user, generating a different reminder comprising the different uncompleted sub-unit of the training unit; and
transmitting the different reminder to the user at another time determined using the personalized predictive behavior model.

14. The system of claim 8, wherein the operations further comprise:
in response to determining that there are no uncompleted sub-units associated with the training unit, generating a notification indicating completion of the training unit; and
transmitting the notification to the user.

15. A computer program product comprising a computer readable storage medium having program instructions embodied therewith, the program instructions executable by a processor to cause the processor to perform operations comprising:
receiving behavior data associated with a user of a training compliance management system;
updating a personalized predictive behavior model associated with the user using the behavior data;
generating, using the personalized predictive behavior model, a training duration, a reminder type, and a reminder time for the user;
generating sub-units of a training unit that each have a completion time within a threshold of the training duration for the user;
generating a reminder based on the reminder type comprising an uncompleted sub-unit of the sub-units of the training unit; and
transmitting the reminder to the user at the reminder time.

16. The computer program product of claim 15, wherein the behavior data further comprises a time of day, a duration of a session, and a type of reminder associated with a previously completed training unit.

17. The computer program product of claim 15, wherein the operations further comprise:
identifying a set of users with a common characteristic; and
generating a semi-specialized predictive behavior model using personalized predictive behavior models corresponding to each user of the set of users.

18. The computer program product of claim 17, wherein the operations further comprise:
receiving an indication of a new user associated with the common characteristic;
generating a training reminder for the new user using the semi-specialized predictive behavior model; and
transmitting the training reminder to the new user at a time determined using the semi-specialized predictive behavior model.

19. The computer program product of claim 15, wherein the reminder type is a text message, a social media message, an email, or a phone call.

20. The computer program product of claim 15, wherein the operations further comprise:
in response to identifying a different uncompleted sub-unit of the training unit associated with the user, generating a different reminder comprising the different uncompleted sub-unit of the training unit; and
transmitting the different reminder to the user at another time determined using the personalized predictive behavior model.
